(19) United States
(12) Patent Application Publication
(10) Pub. No.: US 2002/0089577 A1
(43) Pub. Date: Jul. 11, 2002

(54) Ink jet printer having a printhead assembly for recording high quality graphic images and photo quality images

(75) Inventors: Steven J. Dietl, Ontario, NY (US); Eduardo M. Freire, Webster, NY (US)

Correspondence Address: John E. Beck, Xerox Corporation, Xerox Square 20A, Rochester, NY, 14644, US

(73) Assignee: Xerox Corporation

(21) Appl. No.: 09/755,230

(22) Filed: Jan. 8, 2001

(51) Int. Cl. B41J 2/175

(52) U.S. Cl. 347/87

(57) ABSTRACT

An ink jet printer for recording graphic and photo quality images is provided and includes a frame; a recording medium handling assembly mounted to the frame; and printing assembly including supplies of black, magenta, cyan and yellow liquid inks, and a printhead assembly mounted to the frame. The printhead assembly consists of (i) a first printhead including nozzles each having a first uniform size for recording high quality graphic images on a recording medium, and (ii) a second printhead including a printhead segment for each of the black, magenta, cyan and yellow liquid inks, and each printhead segment including a first set of nozzles having the first uniform size and a second set of nozzles having a second and different size, relative to the first uniform size, for recording photo quality images on the recording medium.

### BACKGROUND OF THE INVENTION

The present invention relates generally to printers such as ink jet printers, and more particularly to such a printer having a printhead assembly or cartridge that is suitable for recording or printing high quality graphic images, and photo quality images.

An ink jet printer of the type frequently referred to as drop-on-demand, has at least one printhead from which droplets of ink are directed towards a recording medium. Within the printhead, the ink is contained in a plurality of channels. Piezoelectric devices or power pulses cause the droplets of ink to be expelled as required, from orifices or nozzles located at the end of the channels. In thermal ink jet printing, the power pulses are usually produced by resistors also known as heaters, each located in a respective one of the channels. The heaters are individually addressable to heat and vaporize the ink in the channels. As a voltage is applied across a selected heater, a vapor bubble grows in that particular channel and ink bulges from the channel nozzle. At that stage, the bubble begins to collapse. The ink within the channel retracts and then separates from the bulging ink thereby forming a droplet moving in a direction away from the channel nozzle and towards the recording medium whereupon hitting the recording medium a spot is formed. The channel is then refilled by capillary action which, in turn, draws ink from a supply container of liquid ink.

The ink jet printhead may be incorporated into either a carriage type printer or a page width type printer. The carriage type printer typically has a relatively small printhead containing the ink channels and nozzles. The printhead is usually sealingly attached to a disposable ink supply cartridge and the combined printhead and cartridge assembly is attached to a carriage which is reciprocated to print one swath of information (equal to the length of a column of nozzles) at a time on a stationary recording medium, such as a sheet of paper or a transparency.

After each such swath is printed, the sheet of paper is transported or advanced forwardly (usually the movement involves stepping or indexing) a distance that is equal to the height of the printed swath or of a portion thereof so that the next printed swath is properly registered in an overlapping or contiguous manner therewith. The procedure is then repeated until an entire page on the sheet is printed.

It has been recognized that there is a need for such an ink jet printer having a printhead assembly that is suitable for recording or printing high quality graphic images, and photo quality images.

### SUMMARY OF THE INVENTION

In accordance with the present invention, there is provided an ink jet printer for recording graphic and photo quality images. The ink jet printer includes a frame; a recording medium handling assembly mounted to the frame; and printing assembly including supplies of black, magenta, cyan and yellow liquid inks, and a printhead assembly mounted to the frame. The printhead assembly consists of (i) a first printhead including nozzles each having a first uniform size for recording high quality graphic images on a recording medium, and (ii) a second printhead including a printhead segment for each of the black, magenta, cyan and yellow liquid inks, and each printhead segment including a first set of nozzles having the first uniform size and a second set of nozzles having a second and different size, relative to the first uniform size, for recording photo quality images on the recording medium.

### BRIEF DESCRIPTION OF THE DRAWINGS

In the detailed description of the invention presented below, reference is made to the drawings, in which:

FIG. 1 is a schematic illustration of a liquid ink printer including the printhead assembly or cartridge, in accordance with the present invention, for printing high quality graphic images and photo quality images;

FIG. 2 is a schematic illustration of the first printhead of the printhead assembly, in accordance with the present invention, for printing high quality graphic images; and

FIG. 3 is a schematic illustration of the second printhead of the printhead assembly, in accordance with the present invention, for printing photo quality images.

### DETAILED DESCRIPTION OF THE INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

Although the present invention discussed herein may be used for drying any image which is created by a liquid ink printer, the description of the present invention will be described in the environment of an ink jet printer such as that shown in the drawings.

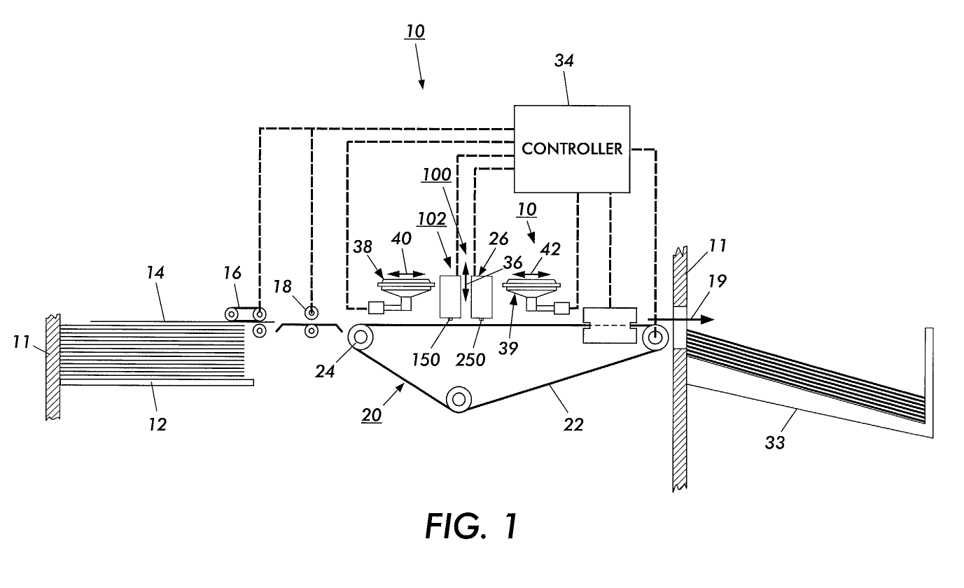

FIG. 1 illustrates a schematic elevational view of a liquid ink printer 10, for instance, an ink jet printer, of the present invention. The liquid ink printer 10 includes a frame 11, and an input tray 12 containing sheets of a recording medium 14 to be printed upon by the printer 10. Single sheets of the recording medium 14 are removed from the input tray 12 by a pickup device 16 and fed by feed rollers 18 to a transport mechanism 20. For printing ink images on a sheet or recording medium 14, the transport mechanism 20 moves the sheet by a feed belt or belts 22 driven by rollers 24 beneath a printing assembly 100 that includes a liquid ink printhead assembly 102. In accordance with the present invention (to be described in detail below), the liquid printhead assembly or cartridge 102 includes at least one printhead 250, or a pair of printheads 150, 250 as shown. After such printing, the recording medium 14 is then carried by the belt 22 through a dryer assembly 32, into an output tray 33.

A controller 34 controls the operation of components of the printer 10, including the printheads 150, 250 and the transport mechanism 20, which includes the pickup device 16, the feed roller 18 and the drive roller 24. In addition, the controller 34 controls the movement of the printhead assembly 102, and particularly printing by the printhead 250 or 150, 250 in accordance with the present invention. The controller 34 can also include a plurality of individual controllers, such as microprocessors or other known devices dedicated to perform a particular function.

At the completion of a printing operation or when otherwise necessary, such as during a power failure, the printhead assembly 102, which is movable in the directions of an arrow 36, is moved away from the belt 22 such that a capping assembly 38, 39 which is movable in the directions of the arrow 40, 42, is moved beneath the printhead assembly 102 for capping the printheads 150, 250. Once the capping assembly 38, 39 is positioned directly beneath the printhead assembly 102, the printhead assembly 102 with the printheads 150, 250, are moved towards the belt 22 and into contact with a plurality of capping gaskets (not shown) located on the capping assembly 38, 39.

Referring now to FIGS. 1-3, preferably, the printhead assembly 102 includes one or more printheads 150, 250 that are each supported in a printing position on the printer frame 11. and in a confronting relation with the belt 22. In accordance with the present invention, in what is referred to as a single-printhead printer, in which the printhead assembly 102 includes only one printhead, the one printhead will have the structure, functions and advantages of the second printhead 250, as is to be described below.

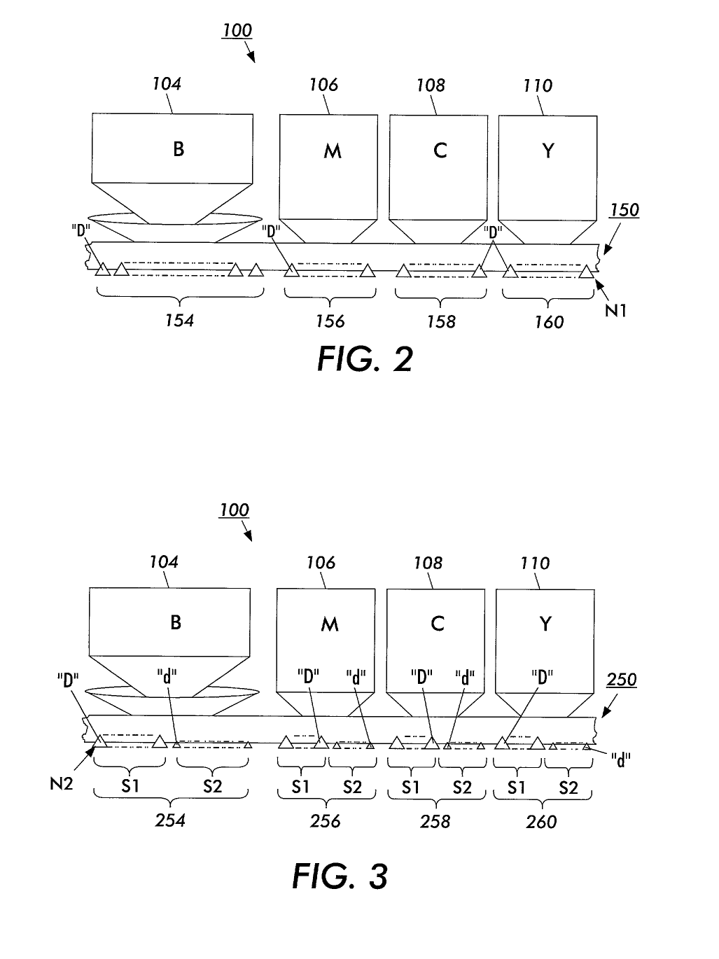

In either case, during printing, the printhead 250 or printheads 150, 250 deposit liquid ink on the recording medium 14 as it is carried by the belt 22 beneath and passed such printheads 150, 250. Each of the printheads 150, 250 includes an array of print nozzles N1, N2 respectively, in accordance with the present invention (to be described in detail below), having a length sufficient to deposit ink in a print zone on the recording medium 14. The present invention is equally applicable to printers having pagewidth array printheads, however, it will be described for example with respect to printers having partial width array, such as one inch array, ink jet printheads. Accordingly, the number of nozzles per array, for example will be 300 nozzles, with a 300 nozzles per inch resolution. As further illustrated (FIGS. 2-3), the printhead assembly 102 is part of a printing assembly 100 that includes ink supplies 104, 106, 108, 110 connected to the printheads 150, 250 through appropriate ink supply conduits.

Referring now to FIGS. 1-3, the printing assembly 100 and/or the printhead assembly 102 may be provided in the form of a cartridge that is replaceable by the user. The ink supplies 104, 106, 108, 110 may be part of the printhead cartridge or they may be replaceable separately from the printheads as part of ink supplies means. As such, and in the case of a single-printhead printer, the present invention could then be directed to a printing cartridge 102 that includes the ink supply means 104, 106, 108, 110, and a printhead 250 for recording quality graphic images and photo quality images on the recording medium 14. As will be described below, the printhead 250 includes a printhead segment for each color ink of black, magenta, cyan and yellow liquid inks, and each such printhead segment includes a first set of nozzles having a first uniform size “D”, and a second set of nozzles having a second and different size “d”, relative to the first uniform size.

Referring now to FIGS. 2-3, the printhead assembly or cartridge 102 is mounted to the frame 11, and alternatively includes or consists of (i) the first printhead 150 including an array of nozzles N1 each having a first uniform size “D” for recording high quality graphic images on the recording medium 14. In accordance with the present invention, the first printhead 150, when a multicolor printhead, includes printhead segments 154, 156, 158,160 for each of the different color liquid inks of black, magenta, cyan and yellow.

The printhead assembly 102 also includes or consists of the second printhead 250 including an array of nozzles N2 for recording photo quality images on the recording medium 14. In accordance with the present invention, the second printhead 250 includes printhead segments 254, 256, 258, 260 for each of the different color liquid inks of black, magenta, cyan and yellow.

Each of the printhead segments 254, 256, 258, 260 of the second printhead 250 includes a first set S1 of nozzles having the first uniform size “D”, and a second set S2 of nozzles having a second and different size “d”, preferably smaller, relative to the first uniform size “D”. The number of nozzles in the first set S1 and those in the second set S2 may be equal, or the number of nozzles in the second set S2 can be within a range of one-third to one-half those in the first set S1.

As also shown, the second printhead 250 preferably is also a multicolor printhead including printhead segments 254, 256, 258, 260 for each color ink of black, magenta, cyan and yellow, and each of the printhead segments 254, 256, 258, 260 that are each connected to a corresponding color ink supply of the ink supplies 104, 106,108, 110. In accordance with the present invention, on the second printhead 250, the printhead segment 254 for black liquid ink includes a first set S1 (of “D” size) and a second set S2 (of “d” size) nozzles that together preferably comprises 40% of a total number of nozzles on the second printhead 250. For example, where the total number of nozzles on the second printhead 250 is equal to 300, the first set S1 nozzles, and the second set S2 nozzles (or 40%) of the total number of nozzles on the second printhead 250, is accordingly 120 nozzles. Relative to the first set S1 (of “D” size nozzles), the second set S2 (of “d” size nozzles) includes a number of nozzles that is equal to ⅓ to ½ the number “D” size nozzles of the first set S1.

Further, in accordance with this aspect of the present invention, the other remaining printhead segments 254, 256, 258, 260 (on the second printhead 250) for magenta, cyan and yellow liquid inks, respectively, also each include a first set S1, (of “D” size) nozzles and a second set S2 of (“d” size) nozzles which together comprise 20% of the total number of nozzles on the second printhead 250.

For example, where the total number of nozzles on the second printhead 250 is equal to 300, the first set (S1) nozzles, and the second set (S2) nozzles (or 20% of the total number of nozzles), is accordingly 60 nozzles. Relative to the first set S1 (of “D” size) nozzles, the second set S2 (of “d” size nozzles) of each of the other remaining printhead segments 256, 258, 260, respectively, includes the number of nozzles that is equal to ⅓ to ½ the number of “D” size nozzles. In either case, each of the printhead segments 254, 256, 258, 260 of the second printhead 250 is connected to the corresponding color ink supply of the ink supplies 104, 106, 108, 110. Preferably, the first set S1 of “D” size nozzles and the second set S2 of “d” size nozzles, of each the printhead segments of the second printhead 250, have an equal number of nozzles, meaning is equal to for each segment.

Specifically, and for example, the first printhead 150 is designed with 120 of its jets or nozzles N1 for black ink, and 60 nozzles each for cyan, magenta and yellow inks, and all nozzles N1 thereof having the one uniform size “D”. The second printhead 250, which is preferably replaceable, is designed with each of the segments 254, 256, 258, 260 for black, magenta, cyan and yellow inks respectively, consisting of two different sets (the first set and the second set S1, S2) of the nozzles N2. The first set S1 of nozzles for each of the segments 254, 256, 258, 260 includes nozzles each having the first uniform size “D”, and the second set S2 thereof includes nozzles having the second and different, preferably smaller, size “d”. The second printhead 250 as such provides excellent, low granularity, and thus photo print quality images even though it basically employs or is based on the same printhead design as the first printhead 150. In fact, the ink tanks or supplies 104, 106, 108, 110 and the fluidic or liquid ink passageways connecting them to the different and appropriate printhead segments 254, 256, 258, 260 are preferably common across both the first and the second printheads 150, 250.

As is illustrated, on the second printhead 250, about one third to one half, preferably one half, of the jets or nozzles N2 of each of the color segments 254, 256, 258, 260 have the second and smaller size “d” so as to produce a spot that is half the size of a spot produced by a nozzle having the size “D”. Advantageously, this enables and allows production of multiple gray levels in the photo mode. For example, if the nozzles having a size “D” each produce a spot size of 60 μm, then the smaller jets or nozzles having the size “d” will each produce a spot size of 20-30 μm. In producing a photo image the printer driver can process the image to be printed so as to place, for any given address, either 1 small drop (equal to a spot), 2 small drops using a nozzles of size “d”, or a single large drop using a nozzle of size “D”. This will allow for very low granularity prints to be made but at the same time also allow a reasonable throughput rate by using only the large jets or nozzles of size “D” in a normal mode text only printing operation, for example.

The drop ejectors or nozzles may each have a rectangular cross section, in which case “D”, “d” can be the diagonal measurements, or they may each have a circular cross-section with “D” and “d” being diameter measurements. In either case, the nozzles preferably are made by patterning a thick polyimide layer as is well known in the art. In order to successfully form small size and large size nozzles from the same polyimide layer, a different method needs to be used for each different size of nozzles. It is recommended to use heaters across the whole array, but to use a heater pit extension for the small size jets or nozzles of size “d”, so as to increase the latency in such nozzles. To do so, it is important to note that making equal size polysilicon heaters and then attempting to cover the ends with thin polyimide is not recommended since it results in high jitter when multiple prepulsing schemes are used. Instead, it is recommended to use different implant doses for the black and color sections. Alternatively a less energy efficient path would be to use black size heaters for the color jets or nozzles but with longer heater setbacks.

For the single-printhead printer alternative including only the printhead 250 having the two different size sets S1, S2, is recommended that the threshold voltage be the same across the whole array of large size and small size nozzles. As pointed out above, the ink tanks or supplies 104, 106, 108, 110, as well as the port manifold, fine manifold, and fluid seals preferably are made common parts across both print heads.

As can be seen, there has been provided an ink jet printer for recording graphic and photo quality images. The ink jet printer includes a frame; a recording medium handling assembly mounted to the frame; and printing assembly including supplies of black, magenta, cyan and yellow liquid inks, and a printhead assembly mounted to the frame. The printhead assembly consists of (i) a first printhead including nozzles each having a first uniform size for recording high quality graphic images on a recording medium, and (ii) a second printhead including a printhead segment for each of the black, magenta, cyan and yellow liquid inks, and each printhead segment including a first set of nozzles having the first uniform size and a second set of nozzles having a second and different size, relative to the first uniform size, for recording photo quality images on the recording medium.

We claim

1. A printing cartridge including:
(a) ink supply means; and
(b) a printhead for recording quality graphic images and photo quality images on the recording medium, said printhead including a printhead segment for each color ink of black, magenta, cyan and yellow liquid inks, and each said printhead segment including a first set of nozzles having a first uniform size, and a second set of nozzles having a second and different size, relative to said first uniform size.

2. An ink jet printer for recording high quality graphic and photo quality images, the ink jet printer comprising:
(a) a frame;
(b) a recording medium handling assembly mounted to said frame; and
(c) a printing assembly including ink supplies of black, magenta, cyan and yellow liquid inks, and a printhead assembly, mounted to said frame, said printhead assembly consisting of a printhead for recording quality graphic images and photo quality images on the recording medium, said printhead including a printhead segment for each color ink of black, magenta, cyan and yellow liquid inks, and each said printhead segment including a first set of nozzles having said first uniform size, and a second set of nozzles having a second and different size, relative to said first uniform size.

3. An ink jet printer for recording high quality graphic and photo quality images, the ink jet printer comprising:
(a) a frame;
(b) a recording medium handling assembly mounted to said frame; and
(c) a printing assembly including ink supplies of black, magenta, cyan and yellow liquid inks, and a printhead assembly, mounted to said frame, said printhead assembly consisting of (i) a first printhead including nozzles each having a first uniform size for recording high quality graphic images on a recording medium, and (ii) a second printhead for recording photo quality images on the recording medium, said second printhead including a printhead segment for each color ink of black, magenta, cyan and yellow liquid inks, and each said printhead segment including a first set of nozzles having said first uniform size, and a second set of nozzles having a second and different size, relative to said first uniform size.

4. The ink jet printer of claim 3, wherein said first printhead is a multicolor printhead including a printhead segment for each color ink of black, magenta, cyan and yellow liquid inks, and each said printhead segment for each color ink of black, magenta, cyan and yellow liquid inks is connected to a corresponding color ink supply of said ink supplies.

5. The ink jet printer of claim 3, wherein each printhead segment of said second printhead, for each color ink of black, magenta, cyan and yellow liquid inks, is connected to a corresponding color ink supply of said ink supplies.

6. The ink jet printer of claim 3, wherein said at least second and different size of each nozzle of said at least second set of nozzles is equal to ⅓ to ½ of said first uniform size.

7. The ink jet printer of claim 3, wherein said first set of nozzles and said second set of nozzles, of each said printhead, have a third and equal number of nozzles.

8. The ink jet printer of claim 5, wherein a printhead segment for black liquid ink includes a first number of nozzles comprising 40% of a total number of nozzles on said first printhead.

9. The ink jet printer of claim 8, wherein said first printhead includes a total number of nozzles equal to 300, and said 40% of said total number of nozzles is 120 nozzles.

10. The ink jet printer of claim 8, wherein printhead segments for magenta, cyan and yellow liquid inks, respectively each include a second number of nozzles comprising 20% of the total number of nozzles on said first printhead.

11. The ink jet printer of claim 10, wherein said second number of nozzles comprises 60 nozzles.
